(19) United States
(12) Patent Application Publication
(10) Pub. No.: US 2001/0019617 A1
(43) Pub. Date: Sep. 6, 2001

(54) Bending wave acoustic device

(76) Inventor: Denis Morecroft, Cambridgeshire (GB)

Correspondence Address: Alan I. Cantor, FOLEY & LARDNER, Washington Harbour, 3000 K Street, N.W., Suite 500, Washington, DC, 20007-5109, US

(21) Appl. No.: 09/770,684

(22) Filed: Jan. 29, 2001

Related U.S. Application Data
(63) Continuation of application No. PCT/GB99/02221, filed on Jul. 26, 1999.

(30) Foreign Application Priority Data
Jul. 29, 1998 (GB) 9816394.2

(51) Int. Cl. H04R 1/00; H04R 9/06

(52) U.S. Cl. 381/423; 381/431

(57) ABSTRACT

An acoustic device, e.g. a loudspeaker, has a transducer (38) coupled via a highly perforate member (36) to an acoustically active area (39) that may be in the form of a skin over part of the highly perforate member. The highly perforate member (36) may be a mesh. Bending waves may be excited in the highly perforate member (36) by the transducer (38) and sound emitted from the acoustically active area (39).

This application is a continuation of International patent application No. PCT/GB99/02221, filed Jul. 26, 1999.

### FIELD OF THE INVENTION

This invention relates to an acoustic device, in particular to a loudspeaker that uses resonant bending wave modes.

### BACKGROUND OF THE INVENTION

Resonant bending wave mode loudspeakers are described in International patent application WO97/09842, counterpart U.S. application Ser. No. 08/707,012, filed Sep. 3, 1996, and several later patent applications all directed to various types of distributed mode loudspeakers.

In such prior distributed mode loudspeakers a resonant member produces sound over substantially its whole surface. Indeed, normally the transducer position and shape of the member are selected so that the resonant modes extend over the surface of the member so that sound is produced evenly over the member, avoiding “hot spots.” The member may comprise a cellular or honeycomb matrix capable of sustaining bending wave action. The matrix is sandwiched between skins to which a transducer is mounted.

### SUMMARY OF THE INVENTION

According to the invention, there is provided an acoustic device comprising a highly perforate member capable of sustaining bending wave action and acoustically substantially inactive, a transducer directly connected to the highly perforate member for electrically applying bending waves in the highly perforate member and an acoustically active member attached to the highly perforate member so as to be coupled to the transducer via the highly perforate member.

By highly perforate is meant a member that defines holes in the member amounting to at least 50%, preferably 70% or further preferably 80% of the surface area of the member. The member can conveniently be in the form of a mesh, with a regular array of holes. The holes can be square, circular, or indeed any shape.

The sound output from the highly perforate member itself can be extremely low. In a normal distributed mode loudspeaker, the sound output from the back of the speaker and the sound output from the front are in antiphase, but they do not interfere because the continuous panel and also any baffles present prevents both sound waves arriving at the same point. In the highly perforate member envisaged by the present invention, substantial cancellation takes place. Moreover, only the solid area of the member can emit sound, and this can be as low as 5% or 10% of the surface area of the member.

The acoustic device may be a loudspeaker.

The invention allows the location of the transducer to be spaced away from the acoustically active area. This allows bending wave technology to be used in applications where the transducer cannot be mounted immediately behind the area intended for sound reproduction.

Preferably, the acoustically active area comprises a skin covering the highly perforate member over the acoustically active area. The skin serves to cover the holes in the highly perforate member. The skin need not itself be capable of bending wave action, because the bending waves are transmitted in the highly perforate member itself.

Preferably, the highly perforate member and the transducer location are as taught to be preferred for distributed mode loudspeakers, for example in International patent application WO97/09842 and counterpart U.S. application Ser. No. 08/707,012. The aspect ratio may be 1 to 0.882 or 1 to 0.707 as taught in those applications.

In embodiments a visual display screen is mounted over part of the highly perforate mesh, and the acoustically active area is provided on the perimeter of the highly perforate member around the visual display screen.

Depending on the geometry required, a plurality of acoustically active areas may be provided on the highly perforate member.

A highly perforate member of preferred shape can be adapted to produce sound over any part of its surface by providing a skin over that part. In this way, a single highly perforate member can be readily adapted for use in a number of different sound reproducing devices without having to manufacture a separate panel member for each application.

The invention also allows distributed mode sound to be output from an area that is far from the preferred aspect ratios. The underlying highly perforate member can be of such a preferred shape, whereas the shape of acoustically active member can be chosen freely.

### BRIEF DESCRIPTION OF THE DRAWINGS

Specific embodiments of the invention will now be described, purely by way of example, with reference to the accompanying drawings in which:

FIG. 1 is a schematic side view of a portion of a loudspeaker according to the invention;

FIGS. 2A, 2B and 2C are plan views showing various transducer locations and acoustically active area locations on a member according to the invention;

FIG. 3 is a perspective view of an acoustic device according to the invention;

FIG. 4A is a top plan view, with parts removed for clarity, of an acoustic device and display screen according to the invention; and

FIG. 4B is a sectional view taken along line 4B-4B in FIG. 4A.

### DETAILED DESCRIPTION

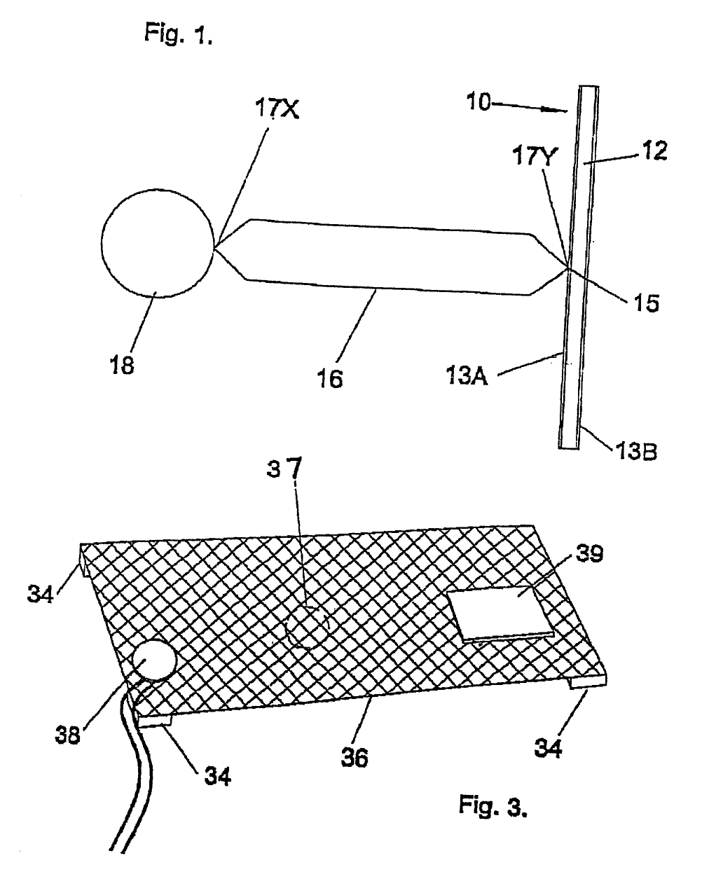

Referring to FIG. 1, a loudspeaker according to the invention comprises a resonant mode panel 10 having a core 12 and skins 13A and 13B. A preferred driving location for the panel 10 is indicated at 15; the panel and driving locations may be as described in published International patent application WO97/09842 and counterpart U.S. application Ser. No. 08/707,012. A bending wave exciting transducer 18 is coupled to the panel 10 by means of a coupling member 16 and sustains bending waves without itself providing significant acoustic output. The coupler 16 has points 17X, 17Y at the coupling location. Such points particularly suit the launch of compression waves into the member 10.

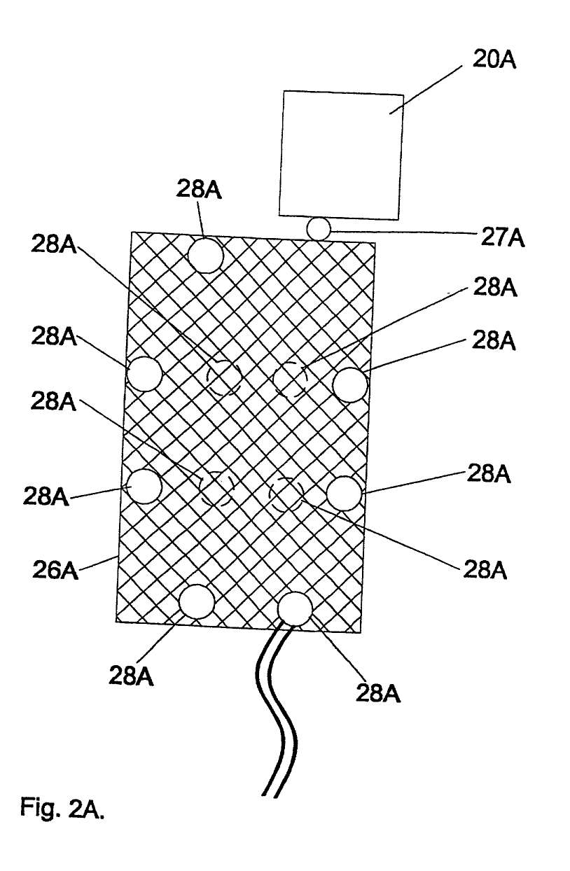

In FIGS. 2A, 2B and 2C, coupling members 26A,B,C are shown as being of perforate or open-work structure, i.e. a mesh. They are proportioned for distributed mode performance in accordance with the teaching of WO97/09842 and U.S. Ser. No. 08/707,012, taking account of any anisotropy of the bending stiffnesses or other parameters. They may be made of any material, preferably a lightweight stiff material such as aluminium. Since the coupling member is perforate, the coupling member 26 does not itself emit significant quantities of sound. Various possible locations for the transducer 28A,B,C are shown in the figures. These locations may either be peripheral locations as shown in solid lines, or in-board eccentric locations as shown in dashed lines in FIG. 2A.

An acoustically active area in the form of a member 20A,B,C is shown coupled to the panel by a coupling 27A,B,C. This may be an edge-to-edge coupling as shown in FIG. 2A, an in-board coupling as shown in FIG. 2B, or a wholly internal coupling as shown in FIG. 2C.

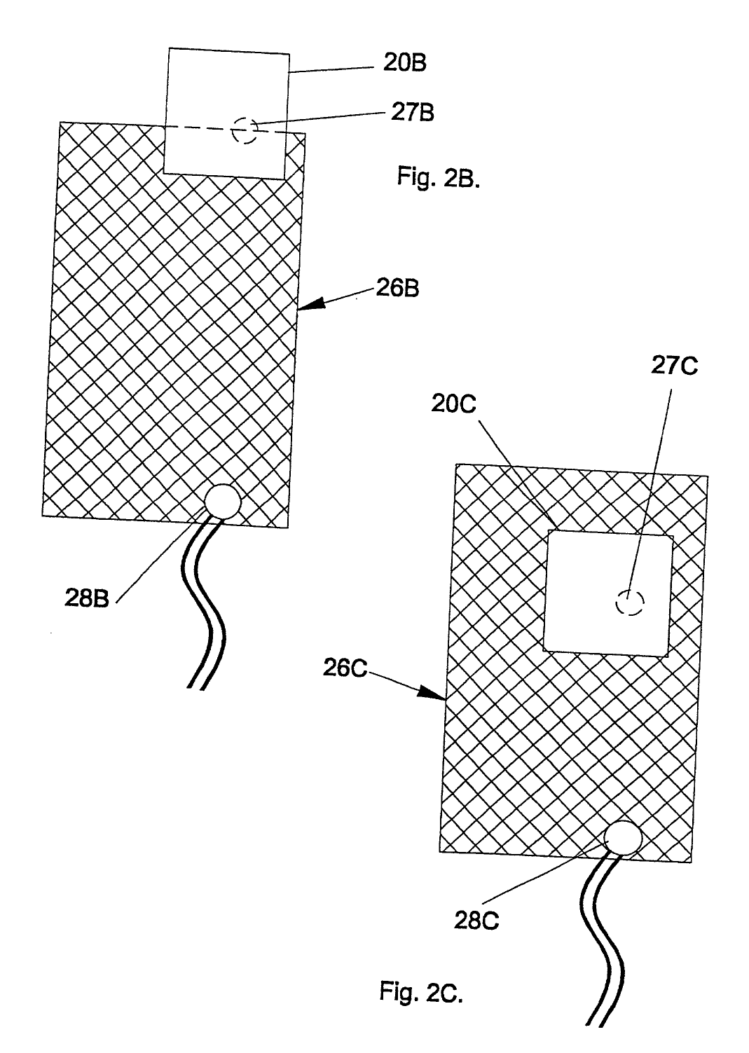

FIG. 3 shows a coupling member 36 with a transducer 38 mounted at a peripheral location. Alternatively, the transducer may be mounted centrally, e.g. at 37. The perforate member is supported by soft supports 34. A skin 39 is provided over a portion of the perforate member and it is from the area of the skin that sound is output. The skin 39 need not have any particular physical requirements except that it must respond to the bending of the underlying perforate member. In particular, the skin 39 need not contribute to the stiffness of the member 36 and preferably does not do so. The skins may be provided at any point over the surface of the member 36, or a plurality of skins may be provided.

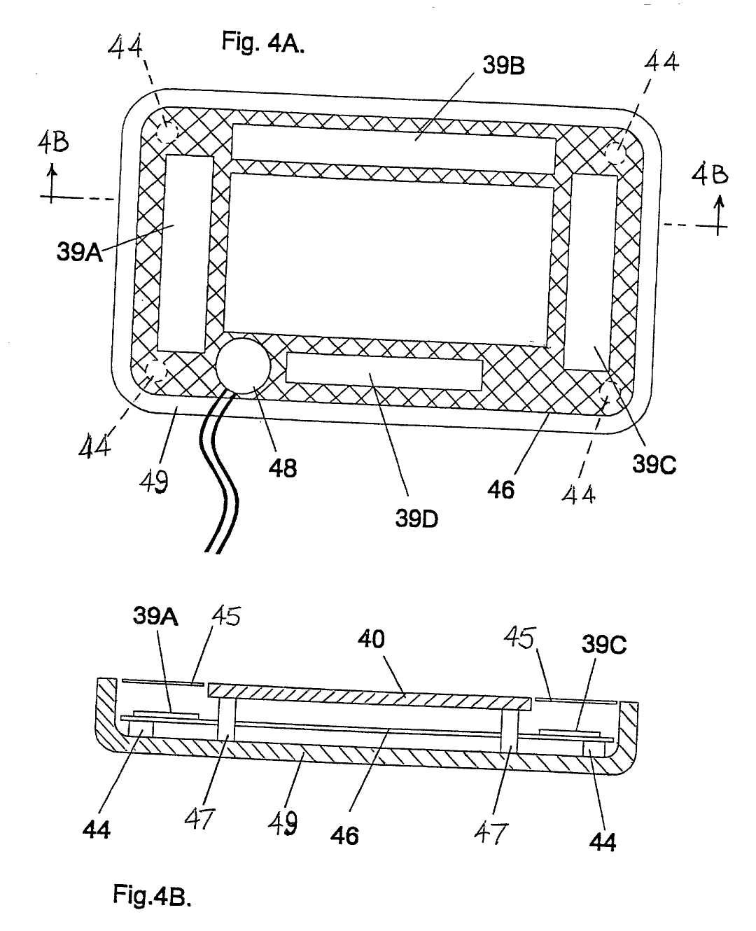

FIGS. 4A and 4B show a beneficially proportioned perforate member 46 with a transducer 48 mounted peripherally. Skins 39A-D are provided at four locations around the periphery of the member 46. A display screen 40 is mounted above the member 46 on supports 47 that extend through the member 46 to the bottom of a dished casing 49. An acoustically transparent covering (not shown in FIG. 4A) lies adjacent display screen 40.

The member 46 is mounted in casing 49 on substantially silent vibrational members 44 at the corners of the members 46. Such members 44 are preferably suitably resilient, and may be mass provided at locations chosen to minimise acoustic effects.

In general, the provision of a skin at desired locations allows much greater flexibility in providing sound output locations above the member. It is not necessary that the active area itself is ideally proportioned, as is the case for conventional distributed mode loudspeakers.

1. An acoustic device comprising:
a highly perforate member capable of sustaining bending wave action and acoustically substantially inactive,
a transducer directly connected to the highly perforate member for electrically applying bending waves in the highly perforate member, and
an acoustically active member attached to the highly perforate member so as to be coupled to the transducer via the highly perforate member.

2. An acoustic device according to claim 1, wherein the highly perforate member is in the form of a mesh having a regular array of holes.

3. An acoustic device according to claim 2, wherein the transducer is spaced away from the acoustically active member.

4. An acoustic device according to claim 3, wherein the acoustically active member is a skin covering the highly perforate member.

5. An acoustic device according to claim 4, wherein the highly perforate member is a distributed mode member shaped to have modes distributed in frequency and over its area and to have preferential locations for mounting a transducer.

6. An acoustic device according to claim 5, wherein the transducer is mounted at one of said preferential locations.

7. An acoustic device according to claim 6, wherein a visual display screen is mounted over a part of the highly perforate member, and the acoustically active member is provided on the perimeter of the highly perforate member around the visual display screen.

8. An acoustic device according to claim 7, having a plurality of acoustically active members provided on the highly perforate member.

9. An acoustic device according to claim 1, wherein the transducer is spaced away from the acoustically active member.

10. An acoustic device according to claim 4, wherein the acoustically active member is a skin covering the highly perforate member.

11. An acoustic device according to claim 1, wherein a visual display screen is mounted over a part of the highly perforate member, and the acoustically active member is provided on the perimeter of the highly perforate member around the visual display screen.

12. An acoustic device according to claim 11, having a plurality of acoustically active members provided on the highly perforate member.

13. An acoustic device according to claim 12, wherein the acoustically active member is a skin covering the highly perforate member.

14. An acoustic device according to claim 1, wherein the highly perforate member is a distributed mode member shaped to have modes distributed in frequency and over its area and to have preferential locations for mounting a transducer.

15. An acoustic device according to claim 14, wherein the transducer is mounted at one of said preferential locations.

16. An acoustic device according to claim 1, wherein the combined area of holes in the highly perforate member is at least about 50% of the total surface area of the perforate member.

17. An acoustic device according to claim 16, wherein the combined area of holes in the highly perforate member is at least about 70% of the total surface area of the perforate member.

18. An acoustic device according to claim 17, wherein the combined area of holes in the highly perforate member is about 80% of the total surface area of the perforate member.

19. An acoustic device comprising:
a highly perforate member capable of sustaining bending wave action and acoustically substantially inactive,
a transducer directly connected to the highly perforate member for electrically applying bending waves in the highly perforate member,
a visual display screen mounted over a part of the highly perforate member, and
an acoustically active skin covering at least part of the perimeter of the highly perforate member around the visual display screen so as to be coupled to the transducer via the highly perforate member and form an acoustically active area adjacent the visual display screen.

20. An acoustic device according to claim 19, wherein the transducer is spaced away from the acoustically active skin.

21. An acoustic device according to claim 20, wherein the acoustically active skin substantially surrounds the visual display screen.

22. An acoustic device according to claim 19, wherein the acoustically active skin substantially surrounds the visual display screen.
